(19) United States
(12) Patent Application Publication
(10) Pub. No.: US 2025/0285500 A1
(43) Pub. Date: Sep. 11, 2025

(54) Method of Playing a Game

(71) Applicants: Richard Borovoy, Boston, MA (US); Eli Borovoy, New York, NY (US)

(72) Inventors: Richard Borovoy, Boston, MA (US); Eli Borovoy, New York, NY (US)

(21) Appl. No.: 18/601,866

(22) Filed: Mar. 11, 2024

(51) Int. Cl. G07F 17/32

(52) U.S. Cl. CPC G07F 17/323; G07F 17/3276; G07F 17/3295

(57) ABSTRACT

A game method where a server executes computer software providing choices to three or more players between multiple options. The server receives player choices and determines from them a majority choice and presents it to the players. The server also provides demographic information about survey respondents who are not players and who made choices between the same set of options. The server provides game betting tokens and receives from the players an estimation of which option was a majority choice of the survey respondents, along with an number of tokens the player bets that their estimation is correct. The server provides scoring information to the players.

### CROSS-REFERENCE TO RELATED APPLICATION

This application claims priority to U.S. Provisional Application No. 63/576,902, filed on Mar. 14, 2023. The disclosure of the prior application is considered part of and is incorporated by reference in the disclosure of this application.

### BACKGROUND OF THE INVENTION AND PRIOR ART

An opinion-based game concept has been used before, most famously the TV game show Family Feud. Family Feud players are asked to guess the majority answers to subjective questions answered by 100 survey participants. Family Feud questions are open ended. For example: “Name something associated with vampires?” Popular player answers are “twilight,” “blood” and “garlic.” Players have to correctly guess the most popular survey participant answers. In Family Feud, the answers made by the players have no effect on future questions, nor are the majority player answers provided to the players to assist them in guessing the answers from the survey participants.

This same type of game is also played in bar settings, for example, a game called Opinionation. In Opinionation, teams of players try to guess the majority response to an open-ended survey question answered by a group of survey respondents. Each game has two rounds with four questions per round. Teams receive points for correctly predicting the survey respondents' majority responses. The team that earns the most points wins.

With the rise of social media and smartphones, people are increasingly interested in expressing and debating their opinions about a topic, for example: What is the best song by Beyonce? Who is the greatest quarterback?; or What is the best place for a beach vacation? While there likely is a need for opinion-based games of various types, e.g. trivia-style bar games and casino games involving betting on players' opinions, there are significant challenges that arise when designing such games. One challenge is the lack of an objective scoring system when scores are based on people's subjective opinions. Another is the need to prevent collusion among players to strategically influence the opinion-based part of the game, to sway scoring in their favor. The method of the invention provides a game that addresses these challenges, resulting in an easily scalable and versatile structured game in which the play is driven by a combination of the opinions of the players and the opinions of another group who previously or subsequently has provided their opinions on the same questions as those presented to the game players.

### SUMMARY OF THE INVENTION

The method of play of the game of this invention incorporates the players' own opinions on the same questions that they are trying to guess another group's opinions. This makes the game more engaging and challenging. In addition, the players' own opinions may be used to direct the flow of the game.

In one embodiment of the invention, players first specify their own answers to a question by choosing between a pair of possible answers, arranged as a March Madness style set of brackets (see FIG. 1). For example, for the “Best Travel Activity” question shown in FIG. 1, the players start by choosing between “Get Sushi at the Fish Market in Japan” and “Go to a Broadway Show”. The choice a majority of the players make on that question is provided to them. Next the players guess what the majority answer to the same question was given by another group of people, for example, survey respondents. The answer that was most popular among the players may be used, to the extent a player wishes, as a guide for making their guess which vacation type was most popular among the survey respondents.

When played in the March Madness style, the players choose one answer from each of the four pairs at the left of FIG. 1, and these four chosen answers are then in turn combined into the two pairs 15 and 16 to the right of the four pairs 11, 12, 13 and 14. The players then choose between the two answers of each of the two pairs 15 and 16, thereby deriving a single pair of answers 17. The players finally select a single answer from this final pair 17, thereby achieving a winning vacation type after having made only seven choices. The other group of respondents, which may, for example, be a surveyed group, would make every choice between any possible pair of choices, requiring twenty-eight choices. Played in this arrayed manner, the players themselves, by their winning answer in each pair of answers, determine which seven of the twenty-eight possible choices they are going to make. Then they try to guess the survey respondents' answers to these same seven questions. Thus, the players' own choices directly influence how the game will unfold.

### DESCRIPTION OF THE DRAWINGS

FIG. 1 shows an example of a game with a question and an array of answers.

FIG. 2 shows a screen available to each player while playing the game.

FIG. 3 shows a score display.

### DETAILED DESCRIPTION OF THE INVENTION

The method of the invention involves a group of three or more players who come together in an in-person or virtual group setting. There may be a central screen showing all the players important information, or alternatively, such information may be displayed on the respective players' smartphones, or to another display via Wifi, Bluetooth, or cellular communication. The players may use their individual smartphones to play the game. During play, game information is provided to a server which makes necessary calculations and determinations needed in the course of play.

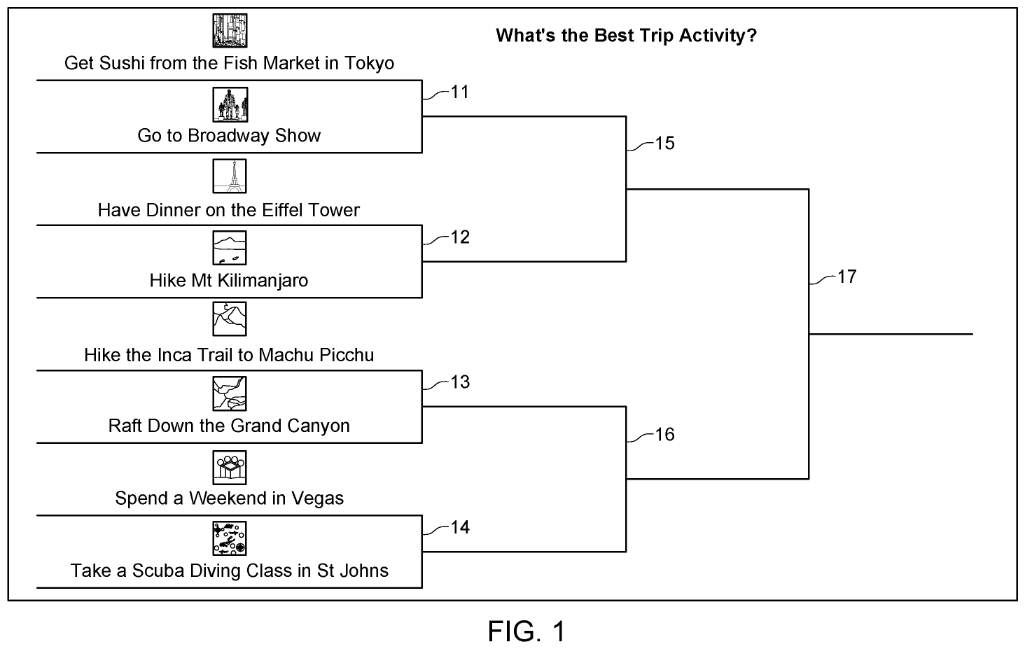

For example, in FIG. 1, the question at the top of FIG. 1 is “What's the best trip activity?” Other examples of questions are “Who is the most amazing winner of all time?”, “What's the best Prestige TV show?”, or “What's the most evocative smell?” Preferably the questions are ones that people have strong opinions about. Survey data comprising answers to those same questions by a group who are not game players is used by the people managing the game. A selected question may be of interest to a particular group of players. For example, a question for a conference on innovation may be “What is the greatest invention of the 20th Century?”

The game has two core components that are interwoven: a selection component and a betting and scoring component. Players express their own opinions by voting on the answers contained in individual answer pairs. In FIG. 1, for example, the first pair 11 in the March Madness style array shown in FIG. 1 is a choice between “Get Sushi” and “Go to a Broadway show.” The best (or most, or worst, or other superlative) vacation activity is chosen by players for each of the pairs of answers 11, 12, 13 and 14 arrayed at the left of FIG. 1, thus generating two pairs of preferred answers 15 and 16 that are chosen by the players from the four pairs of answers 11, 12, 13 and 14 at the left. Next the players choose an answer from each of these two pairs of answers 15 and 16, generating a final pair of answers 17. Finally, the players choose their preferred answer from this last pair of answers 17, generating the winning vacation activity according to the players voting on the question: “What is the best vacation activity?”

After voting themselves on each specific pair of answers, the players then guess what they think another group of people, for example, a group of surveyed people who had or will have expressed their own preferences on the same set of questions, will answer. The players score points by correctly guessing how the surveyed group answered. The number of people surveyed is not critical to the game, but as with all surveys, a larger number usually generates a better result.

Below is an example of the method of the invention where the topic of the game is: What is the best vacation activity?

The bracket of eight provided answers arrayed at the left in FIG. 1 are:
1. Get sushi from the fish market in Tokyo
2. Go to a Broadway show
3. Have dinner on the Eiffel Tower
4. Hike Mt. Kilimanjaro
5. Hike the Inca Trail to Machu Picchu
6. Raft down the Grand Canyon
7. Spend a weekend in Vegas
8. Take a Scuba Diving Class in St. Johns

This array will be displayed to all players as shown in FIG. 1. An even number of answer pairs, such as four pairs 11, 12, 13 and 14 of two answers each in FIG. 1, are randomly arrayed in pairs at the left in FIG. 1. Over the course of the game, players choose which of the eight answers they prefer as the best vacation activity. In this example, the choosing takes place in seven total head-to-head matchups. The winning answer (with the highest vote) of each pair 11, 12, 13 and 14 advances to the next round where there remain only two answer pairs 15 and 16. The winning answer chosen by the players in each of these two answer pairs 15 and 16 advances to the final round where there remains only a single answer pair 17. The vote on the final round of a single answer pair (just as in March Madness) is the winner—the most favored vacation activity chosen by the players.

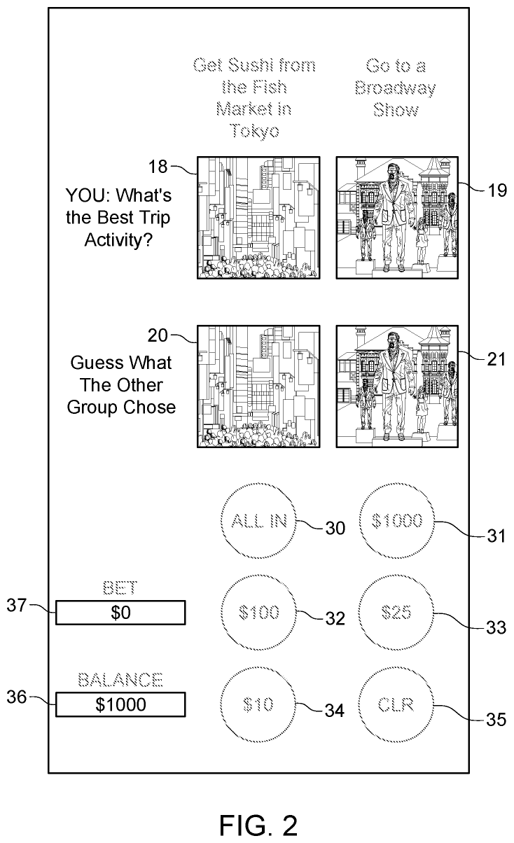

An example of the method of play of the game starts by each player using his or her smartphone to vote on (select) his or her choice of the two answers in each of the first of the four answer pairs 11, 12, 13 and 14 arrayed at the left of FIG. 1, thus making a choice of one of two answers in each pair that the player prefers between the two vacation activities. Preferably, the players vote on one pair at a time, and proceed to the betting/points and scoring step for that pair before voting on the next pair. However, if desired, voting could be done in batches, for example, voting on all four of the answer pairs 11, 12, 13 and 14 at the same time before proceeding to the betting and scoring. The selections made on a player's smartphone are communicated to a server that processes the information. The server determines the answer of each pair which receives more votes from the players. For example, if the players choose “Get Sushi from the Fish Market in Tokyo” from the first pair 11 in FIG. 1, then, as shown in FIG. 2, icon 18 depicting that choice will be highlighted on each of the player's smartphones. If the Broadway Show got more votes, icon 19 will be highlighted.

In the next part of the game played according to a method of the invention, the players guess which of the two answers of each of the pairs of answers they had just voted upon received more votes from another group of people who had previously voted or would in the future vote on the same array of vacation choices. The players enter their guesses on their respective smartphones, and that information is provided to the server. If a player guesses the surveyed group will choose a fish market visit, icon 20 in FIG. 2 will be highlighted. If the player guesses a Broadway show, icon 21 in FIG. 2 will be highlighted. In guessing what the surveyed group would answer, a player may make the same choice that most players in their own group had previously selected, but a player does not have to do this. Even though a player knows that the majority of those playing with him or her chose the Broadway show, for example, that player may still believe, for whatever reason, that the other group would be more likely to choose Sushi at the Fish Market.

The voting results of that other group of people may, for example, have been or will be obtained using a survey. Such surveys can be carried out online. Surveys may be gathered using a third-party survey provider, some of which have a survey-audience of over 50 million people globally. SurveyMonkey, for example, is a company that has a pool of more than 2 million people worldwide who complete and submit surveys. The realism of the game can be enhanced by using a survey of a substantial number of people, for example at least one hundred, to ensure a meaningful and representative target for the game players' guesses. Over time a large dataset of survey questions and actual surveys of people's opinions on many questions can be collected and used later for game setups according to the invention, such as in casinos, bars, via an app in which players can play anywhere on their smartphones against other players anywhere in the world, or over a video call such as Zoom or FaceTime.

In the embodiment of the invention using arrayed pairs, it isn't known until the end of play of a complete set of arrayed pairs which answer pairs of all the possible answers in the array will be selected by the players for voting, as each set of choices the players make determines the next set of choices the players will make. It is therefore important to ask the surveyed population to choose between each possible pair of answers that can be selected from the eight choices at the left of the diagram in FIG. 1, not just the seven pairs of choices 11, 12, 13, 14, 15, 16 and 17 shown in FIG. 1. In that way, no matter which choices move forward in the bracketing scheme, and no matter which pairs of answers move to the right and become subsequent answer pairs along the March Madness style array of FIG. 1, the answer to any possible pairings will be available from the survey data.

From the players perspective, the first round of play allows them to choose from a set of answers that were given to them. However, once a player has chosen an answer from each pair from the first set, in the second set, that player may be choosing among answers he or she had chosen in the first round, or may not if the majority of players did not vote that player's choice, making that subsequent round of choices harder for that player because he or she was invested in his or her first set of preferences. The experience of voting on each pair of answers, hoping that their individual choice will move forward in the brackets, reacting to the collective vote of the group, and anticipating the final winner makes the game significantly more engaging and enjoyable for the players. Also, once players have specified their own choices for each pair, these choices themselves can be used to reveal interesting connections between the players. For example, the game can reveal one player whose opinions were closest to another player or were the most different from another player.

To assist their guessing of the choices made by the other group of people, such as the surveyed group, the players may be provided demographic information about the surveyed group. Such demographic information, for example, may include the region where the group lives, their income, gender, or various preferences of the group on many issues. Other examples of demographics are American teenagers, Californians, women, or even specific, well known, or controversial groups, such as Trump supporters, Democrats, or Q-Anon followers. Having this demographic information enables the players to better assess what people having those demographic characteristics will choose among the answers presented by the game. For example, if players on the West Coast of the United States are told that the people in the surveyed group are from the East Coast, they may be better able to guess the group's responses to the choices in the game than if they did not have that information.

To make the game more fun, the game has a betting aspect. Players use their smartphones to bet some amount of in-game currency on their ability to correctly guess the choices that the respondents of the other group have made or will make. In-game currency may be in the form of points which may be represented by tokens. The tokens may be coins or poker chips, for example. These tokens may be varying sizes or values, each token representing an amount of in-game currency, or they may have actual monetary values if the game is played for real money. They could be coins or other monetary instruments. The amount of the bets are transmitted to the server, for example, using WiFi, Bluetooth, or cellular communication. The players are free to bet as little or as much of their available in-game currency as they want on the correctness of their guesses of what the other group had voted or will vote on each answer pair, the amount mostly likely being based on their confidence in their guesses. Referring to FIG. 2, for example, the players may select bets of “all in” shown in circle 30, meaning a bet of all the betting money they have at the time, or a specific amount shown in circles 31-34. By tapping circle 35 on their display, the players may clear the bets and in order to select others. The amount of a player's selected bet is shown in box 37 and the balance remaining in the player's betting account is shown in box 36.

If desired, the server may determine, and the players may be shown, how much in-game currency is being bet on each answer by all players collectively. If a player correctly guesses the choice of the other group, they can win a predetermined amount of game currency, for example, an amount equal to their bet (e.g. winning a 100 token bet pays an additional 100 tokens). If a player guesses incorrectly, they may lose the amount they bet, or another penalty established by the rules of play.

Players may bet on their guess for each answer pair, on some but not all of the pairs, or perhaps only on the final result, or on whatever portion or combination of answer pairs they desire. Once players have voted on a pair, guessed what the other group of people chose, and bet on the correctness of their guess of the other group's choice, the server displays to the players the answer voted on by a majority of players by highlighting one of icons 18 or 19, and displays which answer the other group of people chose by highlighting one of icons 20 or 21. Players may also be shown the results of their bets (e.g. whether they won or lost or how many tokens they won). In a preferred embodiment, the players are shown the answer given by most of the players before they must make their guess as to how the survey respondents answered the question.

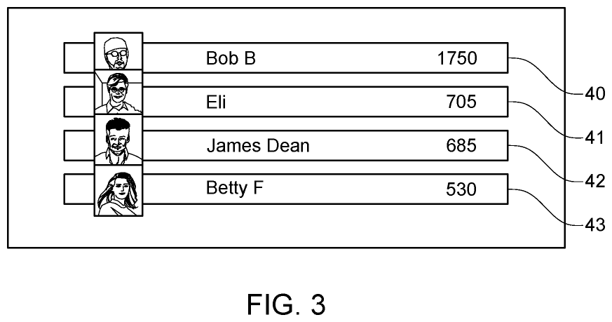

In between bets, players may be shown their aggregate in-game betting scores, such as scores 40, 41, 42 and 43 displayed in FIG. 3. This score may be cumulative across multiple bets, for example, and is shown on a scoreboard on a central screen or individually sent to their phones, or both. This information enables the players to learn how their scores at the time rank against other players.

A full game may proceed by the players doing the following in sequence: 1) Make their own choice on the first answer pair or set of pairs; 2) next make a guess what the other group's choice for the same first answer pair or set of pairs; 3) the players may then place their bets on the correctness of their guess of the other group's choice for the first answer pair or set of pairs on which the players had voted; 4) once all the players have submitted their votes, guesses and bets, in that order, or after a specified amount of time has passed, the players may be provided the results of their own choices for that matchup pair or set of matchup pairs, and also may be provided with their betting scores. Steps 1-4 may be repeated for each of the answer pairs in the array of pairs in the game. In a preferred embodiment, the players are provided with their own majority choice before they are required to choose the other group's choice or place their bets.

For betting, players may begin with a fixed number of points or “chips” (e.g. 1000) available for betting. The players may continually see their winnings or losses displayed in balance box 36 in FIG. 2, as the server will continually update and make available to the players their point or token balance, which continually changes throughout the game. Players may be forbidden from betting more than their token or point balance on any answer pair (although the game rules could permit an amount of “borrowing” if desired, akin to mortgaging properties in Monopoly). Even if a player loses all of his or her balance, and borrowing isn't permitted, he or she may be able to obtain a fixed amount of points (e.g. 25 points) as a “house bonus,” which for example may be offered to players who correctly guess the other group's opinion on any individual choice, any group of choices, or all choices, or on any other basis, which players can use for betting in following rounds.

Players view the betting results on their phones or on a display. This can be done after betting on each pair, after betting on a group of pairs or after betting has been completed on all the pairs and a winner has been determined. Since there are seven total pairs requiring seven choices that players need to make in the matchup array presented in FIG. 1 using an initial set of four choices, after all seven choices have been made, the players will have voted to select a winner.

One way of scoring is to have the player with the most points or tokens in their balance at the end of the game win the game. Prizes for the winner (and potentially second, third, or more place winners) can be determined by the organization offering the game. For example, a gambling casino may choose to give game credits or real gambling chips used in that casino to the winner. Other venues may offer other prizes like free drinks or food or gift cards.

At the end of the game, players may be told who their “Soulmate” and “Nemesis” are. Soulmates are players who, in the above example of a game, voted the most alike across all seven matchups. Nemeses are players who voted least alike. This element of the game is meant to leave players with information at the end of the game to facilitate social interaction among the players. For example, a player may enjoy tracking down his or her soulmate or nemesis so he or she can meet someone new in the social group of players and continue the discussion, or perhaps have a debate with his or her nemesis.

Games may allow the players themselves to choose the subject question of the game via a nomination process, and they may also create an array of answer pairs. Brand specific choices can be used to incorporate promotions, for example the coolest Audi model, or the best White Claw flavor. A version of the game where brackets are dispensed with and the players determine the questions to be asked, answered by themselves, and then guess how another group of people would answer them. That other group could be a surveyed group or merely a group in a different room or different venue.

Another version of the game may allow the players to win or lose points by betting on a chance event in which the matchup answers are chosen at random. This may be done, for example, using a roulette wheel with half of the ball pockets showing one answer of a pair, and the other half showing the other answer. The wheel is then spun, and the winner is determined at random. This chance-based selection model enables a version of the game in which players can be more confident in betting real money, whereas the survey-based version leaves at least some opportunity for collusion, often frowned upon by gambling casinos.

The selection of answers by the random choice system, such as a roulette wheel, can be adjusted based on factors like what percent of players chose answer one vs answer two. In this version, the voting by the players occurs before the random choice is made by the roulette wheel. For example, if ten percent of players chose answer one (of two) as their own choice prior to the random selection, the roulette wheel could be arranged so that answer one takes up ten percent of the pockets, and/or the betting odds could be adjusted accordingly so that, for example, betting on answer one pays 10:1.

Unlike other games, the game played according to the method of the invention, where the players vote first and are told of their collective choices, the results of the game are substantially influenced by the players' own opinions, as opposed to being determined by chance, as with slot machines, or determined by previously known information, such as in the game of Trivia. The method of the invention integrates the players' own subjective opinions, when they themselves first vote, with the opinions of another group voting on the same questions.

Arraying the groups of choices in a March Madness type of array of answer pairs also adds to the enjoyment of the game, as it provides multiple points for betting and a final winner at the end. This arraying also creates more enjoyment, as the players collective earlier choices determine the later answer pairs, requiring refinement of the bets or, in some cases, betting against one's own prior preferences.

The above are preferred embodiments of the method of playing the game of the invention and are not intended as limitations on the scope of the invention as expressed in the claims below.

What is claimed is:

1. A game method comprising:
presenting, by a server executing computer software, a plurality of choices to each of three or more players, each choice being between a plurality of answers;
receiving, by the server, from each player, a respective choice by the player of one answer from the plurality of choices presented to the player;
determining, by the server, from the selections received from the players, a majority answer choice chosen by a majority of the players for each of the plurality of choices, and presenting each majority answer choice to the players;
providing, by the server, to each of the plurality of players, information about a plurality of individuals who are not players and who made their choices between the same plurality of choices for each of the plurality of answers;
providing, by the server, to each of the plurality of players, an amount of game betting tokens;
receiving, by the server, from each of the players for each answer of the plurality of answers, an estimation of which choice was a majority choice of the plurality of individuals, along with an amount of game betting tokens that the players bets that their estimation is correct; and
providing, by the server, to each of the plurality of players, scoring information that includes a number of answers for which the player's estimation was correct.

2. The method of claim 1, wherein the server receives the respective choices and estimations from respective smartphones, each operated by one of the three or more players.

3. The method of claim 1, wherein the game betting tokens represent a game betting currency.

4. The method of claim 1, wherein the information about a prior plurality of individuals is demographic information.

5. The method of claim 1 wherein the plurality of answers are presented by the server as a first plurality of at least four answer pairs, enabling the players to make a choice between each of the first plurality of answer pairs, the chosen answers from the first plurality of answer pairs being presented as a second plurality of at least two answer pairs, enabling the players to make a choice between each of the second plurality of answer pairs, and the process continues until the players make a choice from the last pair, that choice selecting a winner.

6. A game method comprising:
receiving, by a client being used by a player, the player being one of a plurality of players, a plurality of choices, each choice being between a plurality of answers;
receiving, by the respective client, from the player, a respective choice by the player of one answer from the plurality of choices presented to the player;
transmitting, by the client, the respective choices made by the player to a server;
receiving, by the client, a majority answer choice chosen by a majority of the players of the plurality of players, for each of the plurality of choices;
receiving, by the client, information about a prior plurality of individuals who are not players and who made their choices between the same plurality of choices for each of the plurality of answers;
receiving, by the client, an amount of game betting tokens;
receiving, by the client, from the player and for each answer of the plurality of answers, an estimation of which choice was a majority choice of the prior plurality of individuals, along with an amount of game betting tokens that the players bet that their estimation is correct, and transmitting information representing the estimations and the amount of game betting tokens to the server; and
receiving, by the client and from the server, scoring information that includes a number of answers for which the player's estimation was correct.

7. The game method of claim 6, wherein the client is an app running on a smartphone.

8. The method of claim 6 wherein the plurality of answers are received by the client as a first plurality of at least four answer pairs, enabling the players to make a choice between each of the first plurality of answer pairs, the chosen answers from the first plurality of answer pairs being received by the client as a second plurality of at least two answer pairs, and the process continues until the players make a choice from the last pair, that choice selecting a winner.
